(19) United States
(12) Patent Application Publication
(10) Pub. No.: US 2020/0210432 A1
(43) Pub. Date: Jul. 2, 2020

(54) DYNAMIC RE-PARTITIONING FOR INDUSTRIAL DATA

(71) Applicant: General Electric Company, Schenectady, NY (US)

(72) Inventors: Luis RAMOS, San Ramon, CA (US); Sriramakrishna YELISETTI, San Ramon, CA (US); Ramana Venkatesh SIVASUBRAMANIAN, San Ramon, CA (US); Arvind SINGH, San Ramon, CA (US)

(21) Appl. No.: 16/236,762

(22) Filed: Dec. 31, 2018

(51) Int. Cl. G06F 16/2455; G06F 16/21; G06F 16/22

(52) U.S. Cl. CPC G06F 16/24557; G06F 16/2228; G06F 16/212

(57) ABSTRACT

The example embodiments are directed to a system and method for re-partitioning a storage for asset data based on a change in the asset data. In one example, the method may include one or more of monitoring asset data that is being stored in a storage device having a predetermined partitioning scheme, identifying a change in a data pattern of the asset data based on the monitoring, modifying the predetermined partitioning scheme into a different partitioning scheme based on the identified change in the data pattern of the asset data, and storing newly received asset data in the storage device based on the different partitioning scheme as a result of the modifying.

### BACKGROUND

Machine and equipment assets are engineered to perform particular tasks as part of a process. For example, assets can include, among other things, industrial manufacturing equipment on a production line, drilling equipment for use in mining operations, wind turbines that generate electricity on a wind farm, transportation vehicles (trains, subways, airplanes, etc.), gas and oil refining equipment, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the overwhelming adoption of cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

Industrial assets include machinery and equipment used for industry, healthcare, mining, manufacture, oil and gas, transportation, and the like. Data associated with the asset may be captured by sensors, cameras, etc., and fed back to a central platform such as a server, cloud, database, or the like. Typical partitioning of the data is performed on a static basis at the time the asset is deployed. However, over time, data being fed back from an asset may change. For example, a type of data, a frequency of data, a volume of data, and/or the like, may change. As another option, data may be different than expected from the very beginning of the deployment. These changes to expected data patterns can render the original partitioning scheme unsatisfactory causing a slow-down in speed of an application when accessing the data.

### SUMMARY

The embodiments herein improve upon the prior art by providing a dynamic re-partitioning scheme for industrial asset data based on changes in patterns of the data. Industrial data may include time-series data captured by sensors on or about an asset, images or video captured by a camera, audio captured by a microphone, and the like. The data fed back from the asset may be different than expected (e.g., initially, over time, etc.) To address this, the example embodiments re-partition how the data is stored within a back-end storage system such as a database, a cloud, a server, and/or the like. The re-partitioning may optimize how data is being stored in response to changes in the data being fed back. Furthermore, in some embodiments, the re-partitioning of the data may be based on an application that operates/accesses the data. For example, query patterns of the application may be learned by the system, and may be used to organize data in a manner that makes accessing the data more efficient.

Through implementation of dynamic re-partitioning, the system may provide a deterministic performance for users. This can be helpful for applications such as user interfaces (dashboards), analytics (batch and real-time), and others. Furthermore, the dynamic re-partitioning may reduce the cost to serve end users by optimizing back-end hardware resources, and eventually passing the savings to the users.

In an aspect of an example embodiment, a computing system may include a storage device configured to store asset data based on a predetermined partitioning scheme within the storage device, and a processor configured to monitor the asset data and identify a change in a data pattern of the asset data based on the monitoring, modify the predetermined partitioning scheme into a different partitioning scheme based on the identified change in the data pattern of the asset data, and store newly received asset data in the storage device based on the different partitioning scheme as a result of the modification.

In an aspect of another example embodiment, a method may include one or more of monitoring asset data that is being stored in a storage device having a predetermined partitioning scheme, identifying a change in a data pattern of the asset data based on the monitoring, modifying the predetermined partitioning scheme into a different partitioning scheme based on the identified change in the data pattern of the asset data, and storing newly received asset data in the storage device based on the different partitioning scheme as a result of the modifying.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating an industrial cloud computing environment in accordance with an example embodiment.

FIGS. 2A-2B are diagrams illustrating changes in data patterns of an asset over time in accordance with example embodiments.

FIGS. 3A-3B are diagrams illustrating a process of re-partitioning storage of asset data in accordance with an example embodiment.

FIG. 4 is a diagram illustrating a process of duplicating data partitions based on query patterns of the data in accordance with an example embodiment.

FIG. 5 is a diagram illustrating a method for re-partitioning storage of asset data in accordance with an example embodiment.

FIG. 6 is a diagram illustrating a computing system for use with any of the example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

At the scale and speed at which industrial data is captured and fed back to a central storage such as the cloud, it is imperative that retrieval of data for critical industrial applications be fast in order to act on data results which could save machinery, power stations, healthcare equipment, and the like. Traditionally, industrial data is stored in a single data store or data is partitioned based on a pre-determined, arbitrary and often irrelevant static scheme which is irrespective of the actual data that is being stored. As a result, access to the industrial data is inefficient and can consume significant processing resources and create memory waste.

Due to the variety of types, volume, frequency, and the like, of industrial data, it is difficult to partition industrial data in a generic way for all assets. That is, a purely static or purely dynamic approach is not an optimal storage for industrial IoT solutions because such approaches do not adequately represent how data is accessed by industrial applications such as analytics, machine learning algorithms, and the like. The example embodiments utilize both static and dynamic analysis of assets to identify what partitioning strategy is optimal for more critical applications currently relying on the underlying data. Furthermore, the partitioning scheme is not static and can be adjusted continuously based on changes in patterns of the industrial data and learnings from actual data streams. These advantages can help commercially as well as technically by reducing the footprint needed to support applications accessing that data and by providing faster results to those applications.

In a first step, a host platform (e.g., database, distributed database, cloud, etc.) may initially partition a storage for industrial data based on a type of asset from which the data is being provided. In this example, the host platform may initially partition a storage space for industrial data differently based on different types of assets. For example, a wind turbine may provide data on a periodic (e.g., weekly or monthly basis). In this case, the host platform may partition data into partitions of two weeks of data, four weeks of data, or the like. Meanwhile, an aircraft may provide data at five minute increments during a flight. Therefore, the host platform may initially partition the aircraft data into partitions of thirty minutes of data, or the like.

After the data is initially partitioned, the host platform may monitor performance of applications which access the industrial data of an asset stored in the initially partitioned storage area. In some cases, the host platform may detect a change in an attribute (pattern) of the industrial data in comparison to the initial settings. For example, the asset data may be of a different type (e.g., strings, integers, floats, etc.), the asset data may transmitted at different frequencies, different volumes, or the like. In response, the host platform may re-partition the storage area for the asset based on the change in pattern.

Partitioning in a distributed database helps with optimal retrieval of data from databases to a consuming machine/client. Using industrial asset management and classifications, the example embodiments may initialize a partition for an industrial asset with an optimal first-time partition size for that asset data based on a type of the asset (e.g., aircraft, healthcare machine, mining equipment, oil platform, locomotive, etc.) A partition typically holds a chunk of data that has been generated by that asset which correlates to the application usage and retrieval patterns. After the first-time partition is set, the system herein may continue to learn from the data and adjust the partitioning in response. For example, based on the monitoring and learning of the actual data from an asset, the system can adjust its partitioning strategy by physically re-partitioning the data based on the findings from multiple integrated systems. For example, the system may detect that an asset is generating data at a lower frequency than previously determined and thus re-partitioning from one day to one week partitions to optimize retrieval of that data.

The system described herein may be implemented via a program or other software that may be used in conjunction with applications for managing machine and equipment assets hosted within an industrial internet of things (IIoT). An IIoT may connect assets, such as turbines, jet engines, locomotives, elevators, healthcare devices, mining equipment, oil and gas refineries, and the like, to the Internet or cloud, or to each other in some meaningful way such as through one or more networks. The cloud can be used to receive, relay, transmit, store, analyze, or otherwise process information for or about assets and manufacturing sites. In an example, a cloud computing system includes at least one processor circuit, at least one database, and a plurality of users and/or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

Assets may be outfitted with one or more sensors (e.g., physical sensors, virtual sensors, etc.) configured to monitor respective operations or conditions of the asset and the environment in which the asset operates. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

While progress with industrial and machine automation has been made over the last several decades, and assets have become ‘smarter,’ the intelligence of any individual asset pales in comparison to intelligence that can be gained when multiple smart devices are connected together, for example, in the cloud. Aggregating data collected from or about multiple assets can enable users to improve business processes, for example by improving effectiveness of asset maintenance or improving operational performance if appropriate industrial-specific data collection and modeling technology is developed and applied.

The integration of machine and equipment assets with the remote computing resources to enable the IIoT often presents technical challenges separate and distinct from the specific industry and from computer networks, generally. To address these problems and other problems resulting from the intersection of certain industrial fields and the IIoT, the example embodiments provide a system which can re-partition storage of asset data based on unexpected features and changes within the data as it is fed to the storage.

Asset management platforms enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial or healthcare based assets can be uniquely situated to leverage its understanding of assets themselves, models of such assets, and industrial operations or applications of such assets, to create new value for industrial customers through asset insights.

As described in various examples herein, data may include a raw collection of related values of an asset or a process/operation including the asset, for example, in the form of a stream (in motion) or in a data storage system (at rest). Individual data values may include descriptive metadata as to a source of the data and an order in which the data was received, but may not be explicitly correlated. Information may refer to a related collection of data which is imputed to represent meaningful facts about an identified subject. As a non-limiting example, information may be a dataset such as a dataset which has been determined to represent temperature fluctuations of a machine part over time.

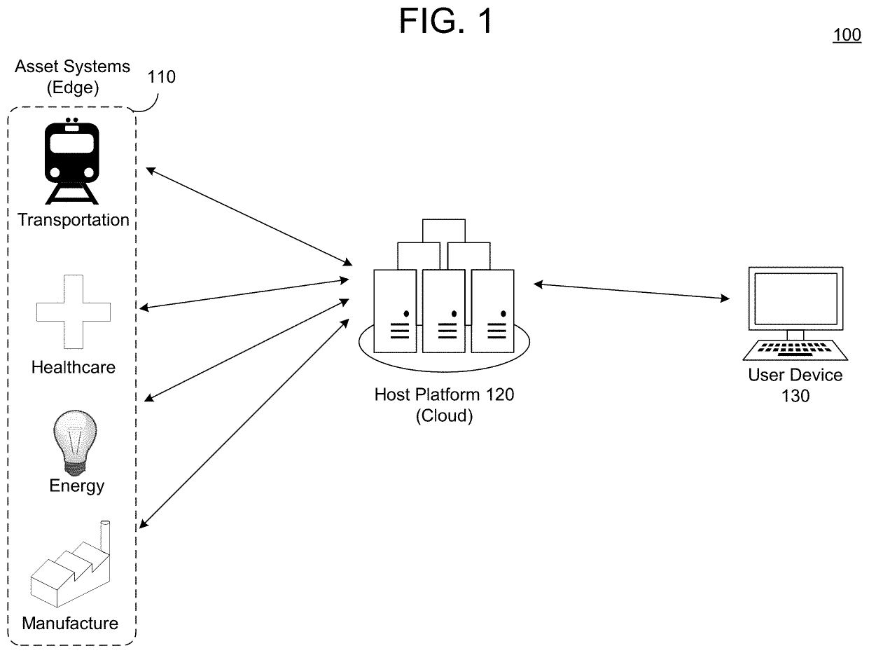

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like. A digital replica (i.e., a digital twin) of an asset 110 may be generated and stored on the cloud platform 120. The digital twin may be used to virtually represent an operating characteristic of the asset 110.

The data transmitted by the assets 110 and received by the cloud platform 120 may include raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets), may be hosted by the cloud platform 120, and may interact with the assets 110. For example, ML models (or AI models) may be used to optimize a performance of an asset or data coming in from the asset. As another example, the ML models may be used to predict, analyze, control, manage, or otherwise interact with the asset and components (software and hardware) thereof. The ML models may also be stored in the cloud platform 120 and/or at the edge (e.g. asset computing systems, edge PC's, asset controllers, etc.) To build these models, the example embodiments provide a cross-domain feature engineering module that can suggest features for use in building a machine learning model. Here, the machine learning model may be designed for a target domain and the features may be detected from other different domains. The module may be incorporated within the cloud platform 120, a user device 130, or the like. As another example, the module may be incorporated within a software application via a library, plug-in, etc.

The user device 130 may receive views of data or other information about the asset as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function, process, operation, etc., of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

Industrial data or asset-related data may include data that has been sensed by one or more sensors that are attached to an asset, sensors positioned within a surrounding environment of an asset, and the like. Asset-related data may include time-series data such as pressure, velocity, temperature, rotational force, noise (audio), humidity, and many others. As another example, asset-related data may include images captured of an asset such as the exterior, interior, hot spots, and the like. As another example, asset-related data may include audio, video, and/or the like. An asset outfitted with particular types sensors may be predicted to need a partitioning scheme based simply on the type of asset, the type of sensors, the role of the asset, the amount of sensors, and the like. However, the data fed back may be different than what was originally expected, or it may vary/change over time such that it no longer is of the type, amount, velocity, etc., that was expected.

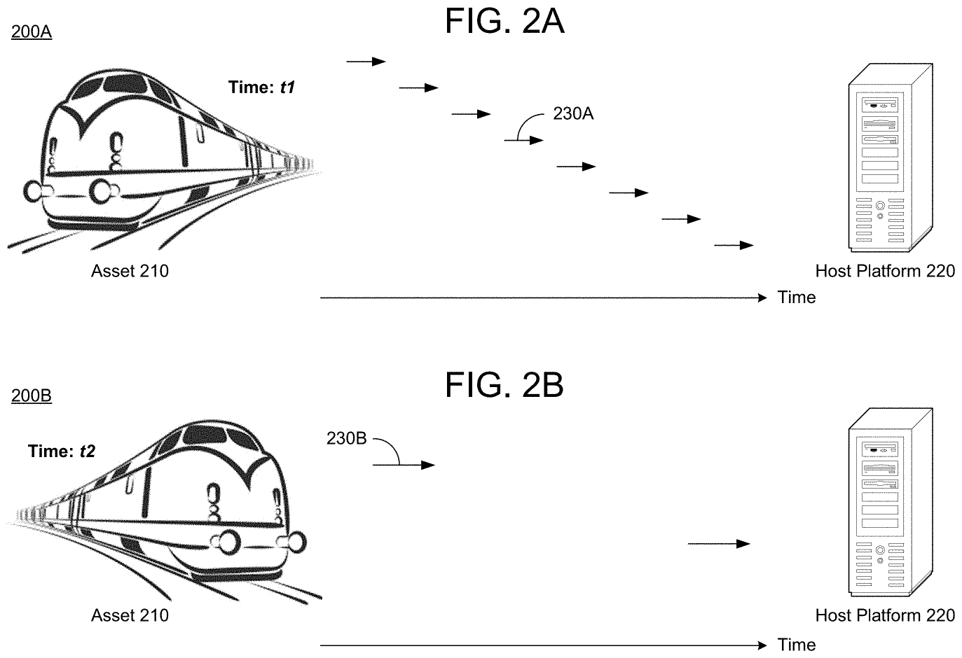

FIGS. 2A-2B illustrate changes in data patterns of an asset over time in accordance with example embodiments. Referring to FIG. 2A, a process 200A of an asset 210 (locomotive) transmitting data to a host platform 220 is shown. Here, the asset 210 may include a computing system or may be monitored by a remote computing system that senses data about the asset 210 and feeds it back to the host platform 220 over time. The host platform 220 may be a database, a server such as an industrial PC, an industrial edge server, a cloud platform, a web server, an asset controller, and the like. In the example of FIG. 2A, the asset 210 feeds back data in daily intervals 230A. This may be an initial setting determined by the host platform 220 based on the asset type being a locomotive. The asset data provided in daily intervals 230A may include pressure, temperature, speed, humidity, a combination thereof, etc. That data may be fed back as tabular data (rows, columns, etc.), XML, data, message data, and the like. There is no limit to the mechanism by which data of the asset 210 is transmitted to the host platform 220.

Referring now to FIG. 2B, a process 200B of the asset 210 transmitting data to the host platform 220 is shown during a second period of time. Here, a pattern of the data being fed back to the host platform 220 by the asset 210 has changed. In this example, the frequency at which the data is being transmitted has changed as well as the volume in which the data is being transmitted. The result is fewer transmission intervals 230B with more data. Here, the transmission intervals 230B may be weekly instead of daily. Changes in data transmission patterns can occur for many different reasons such as change in analytics operating on the asset data, changes in performance of the asset (wear and tear), change in data types set forth by a controller (e.g., string data versus integer data, etc.), upgrades to a system, and the like. Changes may be intentionally implemented or they may be unforeseen.

When the host platform 220 detects changes in the data pattern of the data being fed back from the asset 210 (e.g., a change from the process 200A to the process 200B), the host platform 220 may adjust or modify the partitioning format of the storage for storing the asset data. For example, the host platform 220 may change a size of the partitions by increasing or decreasing a size thereof. As another example, the host platform 220 may change an amount of partitions. As another example, the host platform may change the duration of data that is stored in each partition. For example, a partition may hold one or more hours of data, one or more days of data, one or more weeks of data, one or more months of data, one or more years of data, etc. The host platform can change how much of a time period of data is stored on a partition based on a change in data patterns.

As another example, the host platform 220 may change what data is stored together, and in what duration based on an application that access the data (i.e., the usage pattern of the data by the application). For example, if the host platform 220 determines that an application queries the asset data for pressure data for the past week, the host platform 220 may store the pressure information for the last week together (e.g., in a partition) in the storage area thereby collecting all the data for the query/usage into a single location that can be easily queried and used by the application (e.g., SQL queries, etc.). As time goes by, a data pattern may change and/or a query pattern of the data may change. In response, the host platform 220 can again re-partition how the data is stored within the storage. In some embodiments, the re-partitioning can be retroactive in that all previously stored data is changed to meet the new format. As another example, the re-partitioning can be for all data that comes after a particular starting point in time.

One of the problems solved by this solution is the speed in which a distributed database or other host platform can respond to requests by industrial applications. If the data stored in the distributed database is not stored in an optimal fashion based on the patterns or the needs of the applications relying on the data, then retrieval is slow in comparison and the application can timeout or even fail. This might be acceptable for less critical applications, but not for critical applications (healthcare, public safety, weather, etc.) that need to act in a time sensitive manner.

The example embodiments help accomplish more data transactions with less machines which translates to less computational power needed, less storage space wasted, and overall cost savings. In a technical advantage, the example embodiments provide for faster results because relevant data is stored together based on access patters and therefore provided more quickly to applications enabling insights to data much faster.

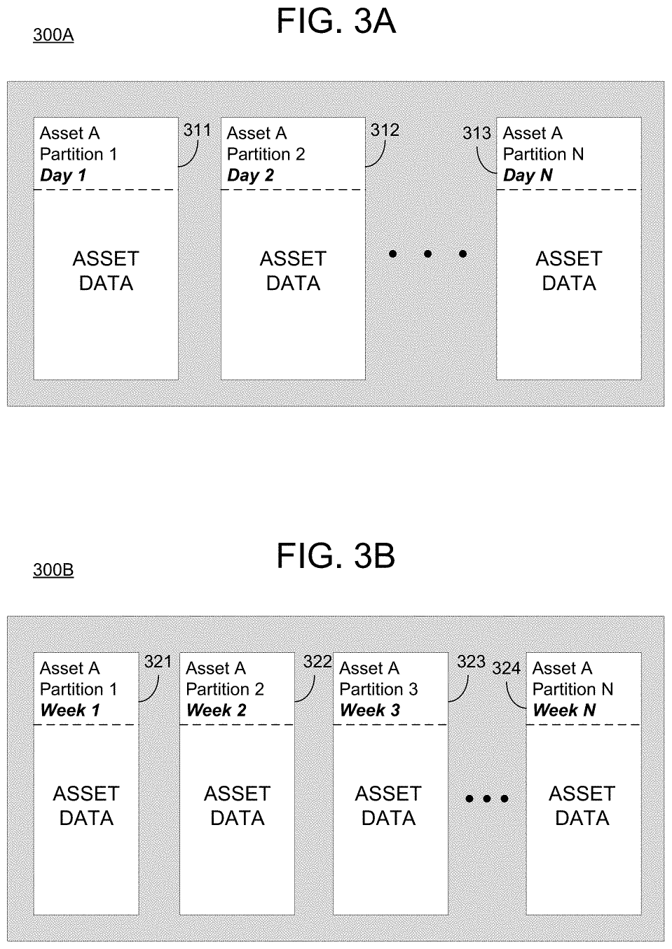

FIGS. 3A-3B illustrate a process of re-partitioning storage of asset data in accordance with an example embodiment. Referring to FIG. 3A, an initial partitioning scheme 300A is shown for storing data from an industrial asset (not shown). In this example, the partitioning scheme 300A partitions data into one day (e.g., 24 hour) partitions of data fed back from the industrial asset. Here, each day's worth of data fed back from the asset is assigned its own partition 311, 312, 313, etc. The initial partitioning scheme 300A may be based on the type of asset. For example, a gas turbine may have a partitioning scheme in which each partition is assigned to a month of data (e.g., temperature, pressure, etc.) Meanwhile, a magnetic resonance imaging (MM) machine may have an initial partitioning scheme in which each partition is assigned to 1 minute of data (images, video, etc.). The initial partitioning scheme may also be based on the applications that are accessing the data.

Meanwhile, in FIG. 3B, a subsequent re-partitioning scheme 300B is shown based on a change in attributes of the data being fed back. In this example, each week of data (e.g., 7 days) of data fed back from the industrial asset is assigned to a partition 321, 322, 323, 324, etc. The re-partitioning may be based on various attributes such as changes in the data being fed back, changes in query patterns of applications, changes in data types, and the like.

In the example of FIGS. 3A and 3B, the initial partitioning scheme 300A and the re-partitioning scheme 300B are based on a duration of time associated with the data feedback. Industrial applications often query data based on specific periods of time such as data over an hour, over a day, over a month, etc. which they can use to analyze and make predictions using machine learning algorithms. By partitioning data based on periods of time, the host platform can optimize data access for applications operating on the data.

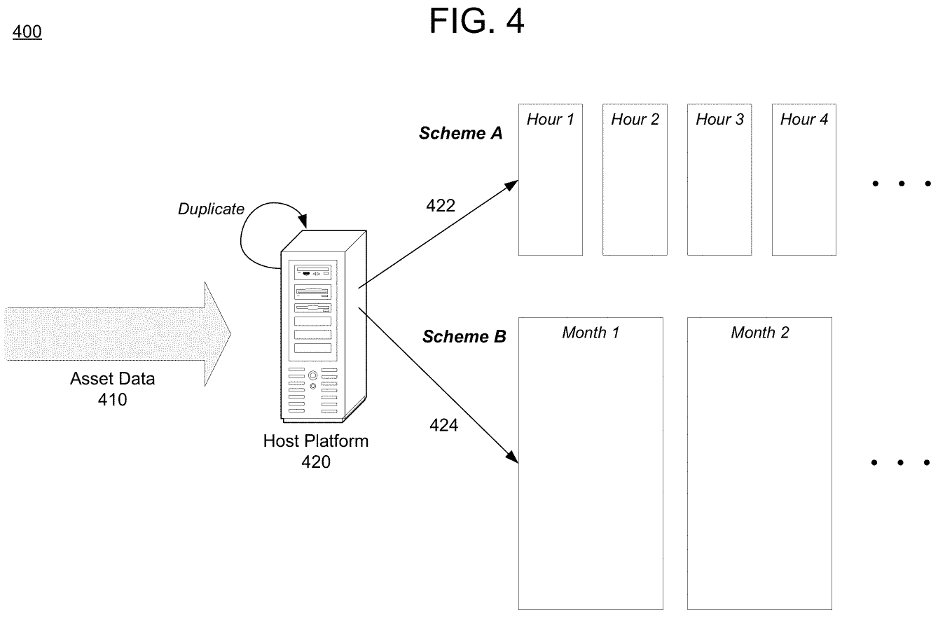

FIG. 4 illustrates a process 400 of duplicating asset data into multiple partitioning schemes based on query patterns in accordance with an example embodiment. In this example, a host platform 420 detects that an application (not shown) regularly asks for asset data 410 in daily increments and in monthly increments. To optimize access patterns, the host platform may partition the asset data 410 into two different partitioning schemes 422 and 424 corresponding to days and months of asset data 410, respectively. Here, the asset data may be duplicated between the storage of the two partitioning schemes 422 and 424. By duplicating the data, the host platform 420 can optimize how the asset data 410 is stored based on query patterns of the application.

In some examples, the system (e.g., host platform 420) may look for various information within the queries being submitted by an application to determine when and how partitioning schemes should be updated. For example, the system may detect that an application is querying data with different window ranges which can trigger the system to create a different partitioning scheme. As another example, the system may detect a number of tags and the frequency (e.g., minute, second, microsecond, nanosecond, etc.) the application is querying/ingesting data. As another example, the system may detect query attributes/predicates. As another example, the system may detect query aggregations or rollups which can provide hints on what pre-aggregations that needs to be performed and its partitions.

Storing asset data (time series data from sensors) in a generic database is difficult because asset data is not one-size fits all. Each asset should be tackled individually. Assets may send data at different frequencies, different types of data (strings, integers, images, video, etc.) Information about what data is being sent from an asset may be stored on a host platform such as in a metadata storage, etc. Since most data is time-based, the host should not rely on the original data setting. Things can change over time, such as amount of data fed back, type of data, frequency of transmission, etc. In other words, the data patterns, amounts, usage, etc. may change over time. For example, a sensor may initially send back data once an hour. However, if the data changes and they start sending data back once a minute instead of once an hour, the original partitioning scheme is inefficient because it will require too many partitions which can slow down the performance of the system.

Based on the knowledge that a host platform may acquire from asset history information, history, usage, etc. the host platform can make a more efficient data store by partitioning by periods of time. Over time, a one-size fits all partitioning scheme becomes very difficult to maintain. Variables that can cause partitioning to change such as changes in the amount of data coming in, changes in the data type (e.g., if they send integers and then send strings), query patterns from applications accessing the data, and the like. For example, an application may submit a certain query about the data (e.g., tell me about what happened in the last week). Based on the learning, the host platform can partition to make that action more efficient to answer by partitioning data in week-long chunks. The changes in partitioning may include a decrease/increase in partition size, a decrease/increase in a number of partitions, duplicate data and movement of data around, and the like.

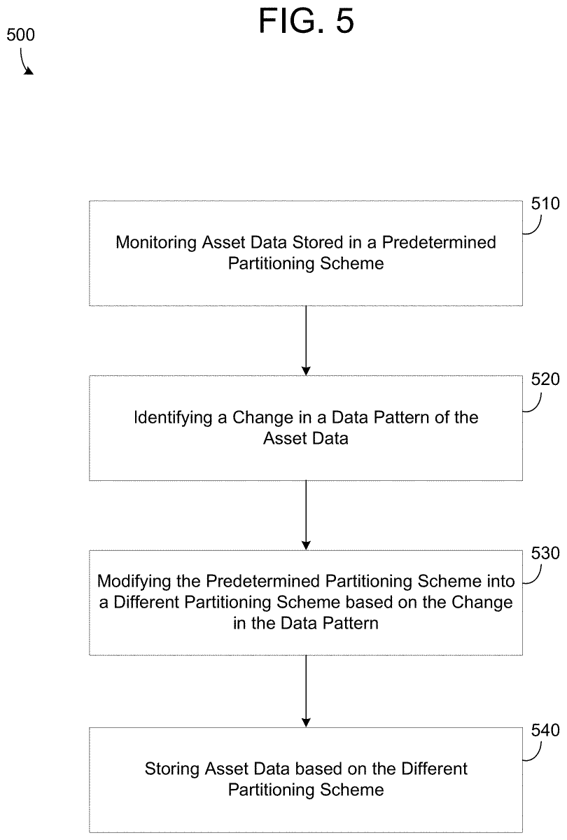

FIG. 5 illustrates a method 500 for re-partitioning storage of asset data in accordance with an example embodiment. For example, the method 500 may be performed by a database, a cloud platform, a server, a user device, a combination of devices, and the like. Referring to FIG. 5, in 510, the method may include monitoring asset data that is being stored in a storage device having a predetermined partitioning scheme. For example, the predetermined partitioning scheme may be an initial partitioning schemed determined based on a type of the asset from among different types of assets such as machine and equipment for use in manufacture, healthcare, transportation, energy production, and the like. The asset data may include time-series data such as pressure, velocity, humidity, temperature, sound, or the like. As another example, the asset data may include images, video, audio, and the like. In some embodiments, the computing system performing the method 500 may also determine/set the initial predetermined partitioning scheme.

In 520, the method may include identifying a change in a data pattern of the asset data based on the monitoring. For example, the change may be a change in one or more attributes of the data being fed back to the computing system where the data is stored. The change may be a change in frequency, a change in volume, a change in data type, a change in access patterns of the data (such as an application query patterns, etc.) In some embodiments, the change may be a change that occurs over time, or it may be a change that happens immediately from the time the asset is deployed meaning the initial partitioning scheme was inefficient from the beginning.

In 530, the method may include modifying the predetermined partitioning scheme into a different partitioning scheme based on the identified change in the data pattern of the asset data. For example, the modifying may include changing a size of a data partition for the asset data, a number of the data partitions, a duration of time of collecting data associated with each partition, and the like. In 540, the method may include storing newly received asset data in the storage device based on the different partitioning scheme as a result of the modifying.

In some embodiments, the modifying may include duplicating a portion of the asset data to generate at least two different partitioning schemes based on query patterns of an application that accesses the asset data in the storage device. In some embodiments, the modifying the predetermined partitioning scheme may include adjusting a duration of time that asset data is collected and stored for a partition. In some embodiments, the method further include determining the predetermined partitioning scheme based on a type of industrial asset associated with the asset data.

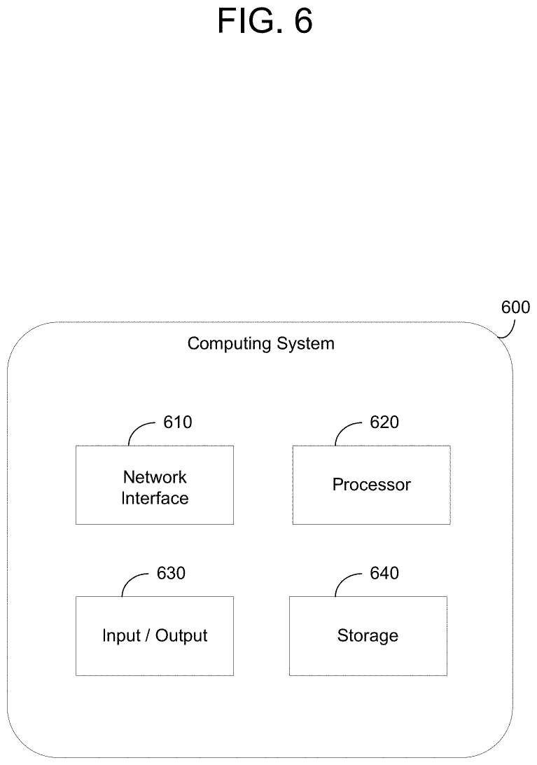

FIG. 6 illustrates a computing system 600 for determining a service contract renewal propensity in accordance with an example embodiment. For example, the computing system 600 may be a cloud platform, a server, a user device, or some other computing device with a processor. Also, the computing system 600 may perform the method of FIG. 5. Referring to FIG. 6, the computing system 600 includes a network interface 610, a processor 620, an input/output 630, and a storage device 640. Although not shown in FIG. 6, the computing system 600 may include other components such as a display, a microphone, a receiver/transmitter, and the like. In some embodiments, the processor 620 may be used to control or otherwise replace the operation of any of the components of the computing system 600.

The network interface 610 may transmit and receive data over a network such as the Internet, a private network, a public network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. The input/output 630 may be a hardware device that includes one or more of a port, an interface, a cable, etc., that can receive data input and output data to (e.g., to an embedded display of the device 600, an externally connected display, an adjacent computing device, a cloud platform, a printer, an input unit, and the like. The storage device 640 is not limited to any particular storage device and may include any known memory device such as RAM, ROM, hard disk, and the like. In some embodiments, the storage 640 may be configured and reconfigured based on a predetermined partitioning scheme, a subsequent re-partitioning scheme, and the like.

According to various embodiments, the storage 640 may store asset data based on a predetermined partitioning scheme within the storage 640. The predetermined partitioning scheme may be determined by the processor 620 based on a type of asset from among a plurality of types of assets associated with different partitioning schemes. The processor 620 may monitor the asset data for a predetermined time period (e.g., an hour, a day, a week, a month, etc.) and identify a change in a data pattern of the asset data based on the monitoring. In response, the processor 620 may modify the predetermined partitioning scheme into a different partitioning scheme based on the identified change in the data pattern of the asset data, and store newly received asset data in the storage 640 based on the different partitioning scheme as a result of the modification.

In some embodiments, the asset data may include time-series data acquired by one or more sensors associated with an industrial machine or equipment. In some embodiments, the processor 620 may identify a change in one or more of a storage frequency of the asset data, a type of the asset data, and a storage volume of the asset data. In some embodiments, the processor 620 may identify a change in query patterns of an application that accesses the asset data in the storage device. In some embodiments, the processor 620 may at least one of increase a partition size and decrease the partition size of each partition in the storage device with respect to a partition size of the predetermined partitioning scheme.

In some embodiments, the processor 620 may duplicate a portion of the asset data to generate at least two different partitioning schemes based on query patterns of an application that accesses the asset data in the storage device. In some embodiments, the processor 620 may adjust a duration of time that asset data is collected and stored for a partition. In some embodiments, the processor 620 may determine the predetermined partitioning scheme based on a type of industrial asset associated with the asset data.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a storage device configured to store asset data based on a predetermined partitioning scheme within the storage device; and
a processor configured to monitor the asset data and identify a change in a data pattern of the asset data based on the monitoring, modify the predetermined partitioning scheme into a different partitioning scheme based on the identified change in the data pattern of the asset data, and store newly received asset data in the storage device based on the different partitioning scheme as a result of the modification.

2. The computing system of claim 1, wherein the asset data comprises time-series data acquired by one or more sensors associated with an industrial machine or equipment.

3. The computing system of claim 1, wherein the processor is configured to identify a change in one or more of a storage frequency of the asset data, a type of the asset data, and a storage volume of the asset data.

4. The computing system of claim 1, wherein the processor is configured to identify a change in query patterns of an application that accesses the asset data in the storage device.

5. The computing system of claim 1, wherein the processor is configured to at least one of increase a partition size and decrease the partition size of each partition in the storage device with respect to a partition size of the predetermined partitioning scheme.

6. The computing system of claim 1, wherein the processor is configured to duplicate a portion of the asset data to generate at least two different partitioning schemes based on query patterns of an application that accesses the asset data in the storage device.

7. The computing system of claim 1, wherein the processor is configured to adjust a duration of time that asset data is collected and stored for a partition.

8. The computing system of claim 1, wherein the processor is further configured to determine the predetermined partitioning scheme based on a type of industrial asset associated with the asset data.

9. A method comprising:
monitoring asset data that is being stored in a storage device having a predetermined partitioning scheme;
identifying a change in a data pattern of the asset data based on the monitoring;
modifying the predetermined partitioning scheme into a different partitioning scheme based on the identified change in the data pattern of the asset data; and
storing newly received asset data in the storage device based on the different partitioning scheme as a result of the modifying.

10. The method of claim 9, wherein the asset data comprises time-series data acquired by one or more sensors associated with an industrial machine or equipment.

11. The method of claim 9, wherein the identifying the change in data pattern of the asset data comprises identifying a change in one or more of a storage frequency of the asset data, a type of the asset data, and a storage volume of the asset data.

12. The method of claim 9, wherein the identifying the change in data pattern comprises identifying a change in query patterns of an application that accesses the asset data in the storage device.

13. The method of claim 9, wherein the modifying comprises at least one of increasing a partition size and decreasing the partition size of each partition in the storage device with respect to a partition size of the predetermined partitioning scheme.

14. The method of claim 9, wherein the modifying comprises duplicating a portion of the asset data to generate at least two different partitioning schemes based on query patterns of an application that accesses the asset data in the storage device.

15. The method of claim 9, wherein the modifying the predetermined partitioning scheme comprises adjusting a duration of time that asset data is collected and stored for a partition.

16. The method of claim 9, wherein the method further comprises determining the predetermined partitioning scheme based on a type of industrial asset associated with the asset data.

17. A non-transitory computer readable medium storing instructions which when executed cause a computer to perform a method comprising:
monitoring asset data that is being stored in a storage device having a predetermined partitioning scheme;
identifying a change in a data pattern of the asset data based on the monitoring;
modifying the predetermined partitioning scheme into a different partitioning scheme based on the identified change in the data pattern of the asset data; and
storing newly received asset data in the storage device based on the different partitioning scheme as a result of the modifying.

18. The non-transitory computer readable medium of claim 17, wherein the asset data comprises time-series data acquired by one or more sensors associated with an industrial machine or equipment.

19. The non-transitory computer readable medium of claim 17, wherein the identifying the change in data pattern of the asset data comprises identifying a change in one or more of a storage frequency of the asset data, a type of the asset data, and a storage volume of the asset data.

20. The non-transitory computer readable medium of claim 17, wherein the modifying comprises at least one of increasing a partition size and decreasing the partition size of each partition in the storage device with respect to a partition size of the predetermined partitioning scheme.
